(19) United States
(12) Patent Application Publication
(10) Pub. No.: US 2018/0219402 A1
(43) Pub. Date: Aug. 2, 2018

(54) Wireless Charging System With Inverter Input Power Control

(71) Applicant: Apple Inc., Cupertino, CA (US)

(72) Inventor: Weiyun Chen, Los Gatos, CA (US)

(21) Appl. No.: 15/812,894

(22) Filed: Nov. 14, 2017

Related U.S. Application Data
(60) Provisional application No. 62/453,842, filed on Feb. 2, 2017.

(51) Int. Cl. H02J 7/02; H02J 50/10; H02M 7/5395

(52) U.S. Cl. CPC H02J 7/025; H02M 7/5395; H02J 50/10

(57) ABSTRACT

A wireless power transmitting device transmits wireless power signals to a wireless power receiving device using a wireless power transmitting coil. The wireless power receiving device has a rectifier and a wireless power receiving coil that receives wireless power signals. The rectifier supplies an output power to a battery charger integrated circuit. The wireless power transmitting device measures input power supplied to an inverter. The inverter supplies drive signals to the wireless power transmitting coil with a duty cycle. The transmitting device uses information on the input power, output power, and a power level demanded by the battery charger integrated circuit to make duty cycle adjustments. The duty cycle adjustments are used to identify a duty cycle setting at which the input power is minimized while the power demanded by the battery charger integrated circuit is satisfied by the output power.

This application claims the benefit of provisional patent application No. 62/453,842, filed Feb. 2, 2017, which is hereby incorporated by reference herein in its entirety.

### FIELD

This relates generally to wireless systems, and, more particularly, to systems in which devices are wirelessly charged.

### BACKGROUND

In a wireless charging system, a wireless power transmitting device such as a device with a charging surface wirelessly transmits power to a portable electronic device. The portable electronic device receives the wirelessly transmitted power and uses this power to charge an internal battery and to power components in the portable electronic device.

It can be challenging to regulate the flow of wireless power in a wireless charging system, particularly in an operating environment in which parameters such as coupling coefficient and load power consumption have the potential to change over time. If care is not taken, power transfer efficiency may not be optimal.

### SUMMARY

A wireless power transmitting device transmits wireless power signals to a wireless power receiving device using a wireless power transmitting coil. The wireless power receiving device has a wireless power receiving coil that receives wireless power signals and has a rectifier that rectifies the wireless power signals. The rectifier is coupled to an integrated circuit such as a battery charger integrated circuit and supplies an output power to the battery charger integrated circuit. Output power sensor circuitry measures the output power.

The wireless power transmitting device has input power sensor circuitry that measures input power supplied to an inverter. The inverter supplies drive signals to the wireless power transmitting coil with a duty cycle. Transmitting device control circuitry in the wireless power transmitting device communicates wirelessly with receiving device control circuitry in the wireless power receiving device.

During operation, the transmitting device control circuitry measures input power. The receiving device measures output power from the output power sensor circuitry, and information on the power level demanded by the battery charger integrated circuit to determine duty cycle adjustment requirements. The receiving device wirelessly transmits duty cycle adjustment requirement information to the transmitting device control circuitry such as information on the output power and demanded power using the receiving device control circuitry. The duty cycle is adjusted from the transmitter side by using the transmitting device control circuitry to establish a duty cycle setting at which the input power is minimized while the power demanded by the battery charger integrated circuit is satisfied by the output power.

### BRIEF DESCRIPTION OF THE DRAWINGS

FIG. 1 is a schematic diagram of an illustrative wireless charging system in accordance with embodiments.

FIG. 2 is a top view of an illustrative wireless power transmitting device with an array of coils that forms a wireless charging surface in accordance with an embodiment.

FIG. 3 is a circuit diagram of an illustrative wireless charging system in accordance with an embodiment.

FIG. 4 is graph in which output power has been plotted as a function of load resistance for an illustrative wireless charging system in accordance with an embodiment.

FIG. 5 is a graph in which power transfer efficiency has been plotted as a function of load resistance for an illustrative wireless charging system in accordance with an embodiment.

FIG. 6 is a flow chart of illustrative operations involved in using a wireless charging system in accordance with an embodiment.

### DETAILED DESCRIPTION

A wireless power system has a wireless power transmitting device that transmits power wirelessly to a wireless power receiving device. The wireless power transmitting device is a device such as a wireless charging mat, wireless charging puck, wireless charging stand, wireless charging table, or other wireless power transmitting equipment. The wireless power transmitting device has one or more coils that are used in transmitting wireless power to one or more wireless power receiving coils in the wireless power receiving device. The wireless power receiving device is a device such as a cellular telephone, watch, media player, tablet computer, pair of earbuds, remote control, laptop computer, other portable electronic device, or other wireless power receiving equipment.

During operation, the wireless power transmitting device supplies alternating-current drive signals to one or more wireless power transmitting coils. This causes the coils to transmit alternating-current electromagnetic signals (sometimes referred to as wireless power signals) to one or more corresponding coils in the wireless power receiving device. Rectifier circuitry in the wireless power receiving device converts received wireless power signals into direct-current (DC) power for powering the wireless power receiving device.

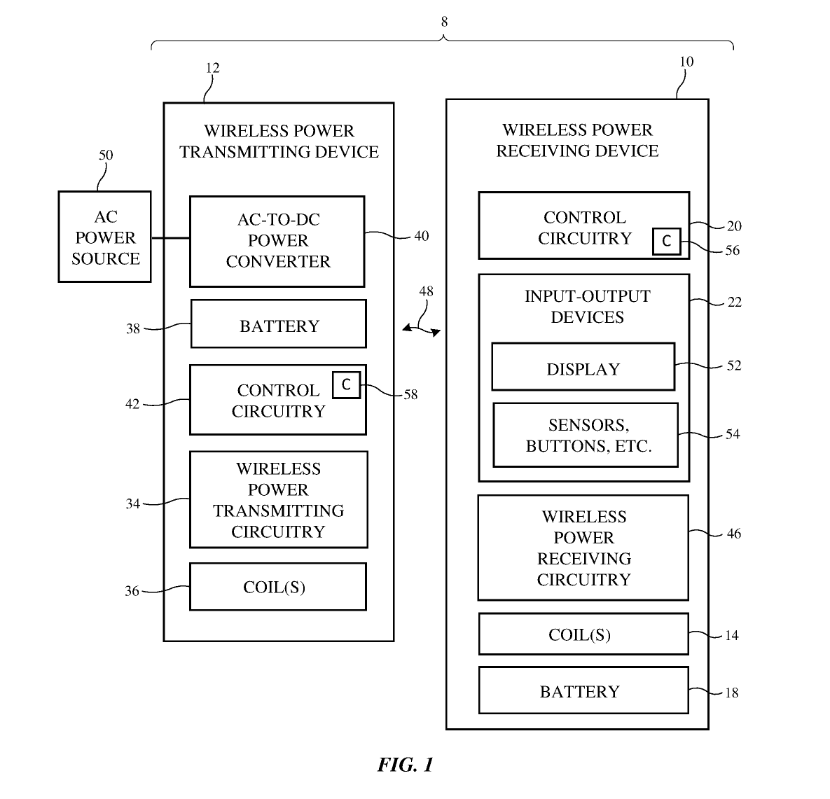

An illustrative wireless power system (wireless charging system) is shown in FIG. 1. As shown in FIG. 1, wireless power system 8 includes wireless power transmitting device 12 and one or more wireless power receiving devices such as wireless power receiving device 10. Device 12 may be a stand-alone device such as a wireless charging mat, may be built into furniture, or may be other wireless charging equipment. Device 10 is a portable electronic device such as a wristwatch, a cellular telephone, a tablet computer, or other electronic equipment. Illustrative configurations in which device 12 is a mat or other equipment that forms a wireless charging surface and in which device 10 is a portable electronic device that rests on the wireless charging surface during wireless power transfer operations are sometimes be described herein as examples.

During operation of system 8, a user places one or more devices 10 on the charging surface of device 12. Power transmitting device 12 is connected to a source of alternating-current voltage such as alternating-current power source 50 (e.g., a wall outlet that supplies line power or other source of mains electricity), has a battery such as battery 38 for supplying power, and/or is connected to another source of power. A power converter such as alternating-current-to-direct current (AC-DC) power converter 40 can convert power from a mains power source or other alternating-current (AC) power source into direct-current (DC) power that is used to power control circuitry 42 and other circuitry in device 12. During operation, control circuitry 42 uses wireless power transmitting circuitry 34 and one or more coil(s) 36 coupled to circuitry 34 to transmit alternating-current electromagnetic signals 48 to device 10 and thereby convey wireless power to wireless power receiving circuitry 46 of device 10.

Power transmitting circuitry 34 has switching circuitry (e.g., transistors in an inverter circuit) that are turned on and off based on control signals provided by power transmitting device control circuitry 42 to create AC signals (drive signals) through coil(s) 36. As the AC signals pass through coil(s) 36, alternating-current electromagnetic fields (wireless power signals 48) are produced that are received by corresponding coil(s) 14 coupled to wireless power receiving circuitry 46 in receiving device 10. When the alternating-current electromagnetic fields are received by coil 14, corresponding alternating-current currents and voltages are induced in coil 14. Rectifier circuitry in circuitry 46 converts received AC signals (received alternating-current currents and voltages associated with wireless power signals) from coil(s) 14 into DC voltage signals for powering device 10. The DC voltages are used in powering components in device 10 such as display 52, touch sensor components and other sensors 54 (e.g., accelerometers, force sensors, temperature sensors, light sensors, pressure sensors, gas sensors, moisture sensors, magnetic sensors, etc.), wireless communications circuitry 56 for communicating wirelessly with corresponding wireless communications circuitry 58 in control circuitry 42 of wireless power transmitting device 12 and/or other equipment, audio components, and other components (e.g., input-output devices 22 and/or wireless receiving device control circuitry 20) and are used in charging an internal battery in device 10 such as battery 18.

Devices 12 and 10 include, respectively, wireless transmitting device control circuitry 42 and wireless receiving device control circuitry 20. Control circuitry 42 and 20 includes storage and processing circuitry such as microprocessors, power management units, baseband processors, digital signal processors, microcontrollers, and/or application-specific integrated circuits with processing circuits. Control circuitry 42 and 20 is configured to execute instructions for implementing desired control and communications features in system 8. For example, control circuitry 42 and/or 20 may be used in determining power transmission levels, processing sensor data, processing user input, processing other information such as information on wireless coupling efficiency from transmitting circuitry 34, processing information from receiving circuitry 46, using information from circuitry 34 and/or 46 such as signal measurements on output circuitry in circuitry 34 and other information from circuitry 34 and/or 46 to determine when to start and stop wireless charging operations, adjusting charging parameters such as charging frequencies, the duty cycle of the alternating-current signal supplied to coils 36 to wirelessly transmit power, coil assignments in a multi-coil array, and wireless power transmission levels, the direct-current (DC) value of the direct-current power source, and performing other control functions.

Control circuitry 42 and 20 may be configured to support wireless communications between devices 12 and 10 (e.g., control circuitry 20 may include wireless communications circuitry such as circuitry 56 and control circuitry 42 may include wireless communications circuitry such as circuitry 58).

Control circuitry 42 and/or 20 may be configured to perform its communications and control operations using hardware (e.g., dedicated hardware or circuitry) and/or software (e.g., code that runs on the hardware of system 8). Software code for performing these operations is stored on non-transitory computer readable storage media (e.g., tangible computer readable storage media). The software code may sometimes be referred to as software, data, program instructions, instructions, or code. The non-transitory computer readable storage media may include non-volatile memory such as non-volatile random-access memory (NVRAM), one or more hard drives (e.g., magnetic drives or solid state drives), one or more removable flash drives or other removable media, other computer readable media, or combinations of these computer readable media or other storage. Software stored on the non-transitory computer readable storage media may be executed on the processing circuitry of control circuitry 42 and/or 20. The processing circuitry may include application-specific integrated circuits with processing circuitry, one or more microprocessors, or other processing circuitry.

Device 12 and/or device 10 may communicate wirelessly during operation of system 8. Devices 10 and 12 may, for example, have wireless transceiver circuitry in control circuitry 42 and 20 (see, e.g., wireless communications circuitry such as circuitry 58 and 56 of FIG. 1) that allows wireless transmission of signals between devices 10 and 12 (e.g., using antennas that are separate from coils 36 and 14 to transmit and receive unidirectional or bidirectional wireless signals, using coils 36 and 14 to transmit and receive unidirectional or bidirectional wireless signals, etc.).

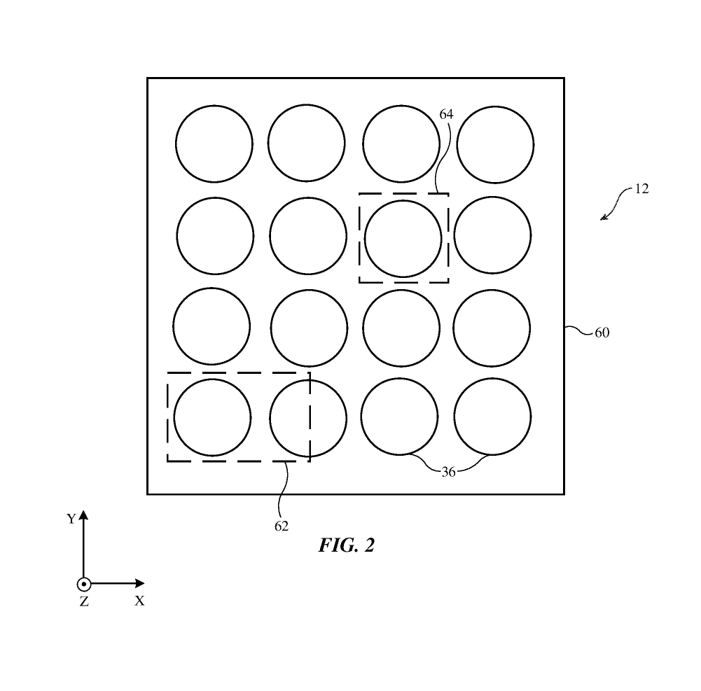

With one illustrative configuration, wireless transmitting device 12 is a wireless charging mat or other wireless power transmitting equipment that has an array of coils 36 that supply wireless power over a wireless charging surface. This type of arrangement is shown in FIG. 2. In the example of FIG. 2, device 12 has an array of coils 36 that lie in the X-Y plane. Coils 36 of device 12 are covered by a planar dielectric structure such as a plastic member or other structure forming charging surface 60. The lateral dimensions (X and Y dimensions) of the array of coils 36 in device 36 may be 1-1000 cm, 5-50 cm, more than 5 cm, more than 20 cm, less than 200 cm, less than 75 cm, or other suitable size. Coils 36 may overlap or may be arranged in a non-overlapping configuration. Coils 36 can be placed in a rectangular array having rows and columns and/or may be tiled using a hexagonal tile pattern or other pattern.

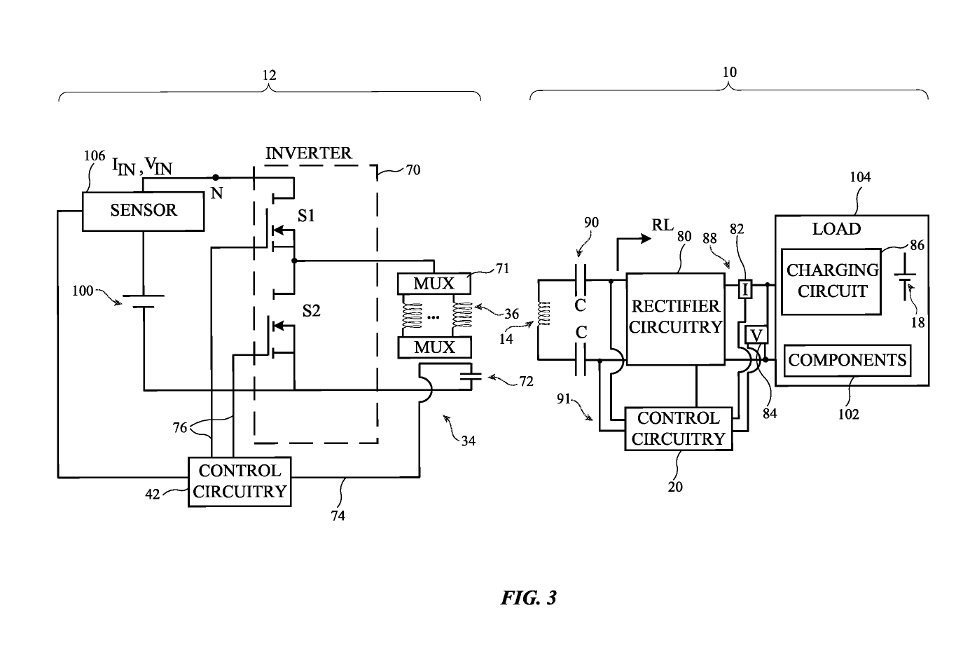

A circuit diagram of illustrative circuitry for wireless power transfer (wireless power charging) system 8 is shown in FIG. 3. As shown in FIG. 3, wireless power transmitting circuitry 34 includes an inverter such as inverter 70 or other drive circuit that produces alternating-current drive signals such as variable duty-cycle square waves or other drive signals in response to variable duty-cycle square waves or other control signals on path 76 from control circuitry 42. The alternating-current drive signals (e.g., the variable-duty-cycle square waves) are driven through an output circuit that includes coil(s) 36 and capacitor(s) 72 to produce wireless power signals that are transmitted wirelessly to device 10.

Coil(s) 36 are electromagnetically coupled with coil(s) 14. A single coil 36 and single corresponding coil 14 are shown in the example of FIG. 3. In general, device 12 may have any suitable number of coils (1-100, more than 5, more than 10, fewer than 40, fewer than 30, 5-25, etc.) and device 10 may have any suitable number of coils. Switching circuitry MUX (sometimes referred to as multiplexer circuitry) that is controlled by control circuitry 42 can be located before and/or after each coil (e.g., before and/or after each coil 36 and/or before and/or after the other components of output circuit 71 in device 12) and can be used to switch desired sets of one or more coils (e.g., coils 36 and output circuits 71 in device 12) into or out of use. For example, if it is determined that device 10 is located in location 62 of FIG. 2, the coil(s) 36 overlapping device 10 at location 62 may be activated during wireless power transmission operations while other coils 36 (e.g., coils not overlapped by device 10 in this example) are turned off. If desired, multiple devices 10 may rest on surface 60 simultaneously (e.g., at location 62 and one or more additional locations such as location 64).

Control circuitry 42 and control circuitry 20 contain wireless transceiver circuits (e.g., circuits such as wireless communication circuitry 56 and 58 of FIG. 1) for supporting wireless data transmission between devices 12 and 10. In device 10, control circuitry 20 (e.g., communications circuitry 56) can use path 91 and coil 14 to wirelessly transmit data to device 12. In device 12, paths such as path 74 may be used to supply incoming data signals that have been wirelessly received from device 10 using coil 36 to demodulating (receiver) circuitry in communications circuitry 58 of control circuitry 42. If desired, path 74 may be used in transmitting wireless data to device 10 with coil 36 that is received by receiver circuitry in circuitry 56 of circuitry 20 using coil 14 and path 91. Configurations in which circuitry 56 of circuitry 20 and circuitry 58 of circuitry 42 have antennas that are separate from coils 36 and 14 may also be used for supporting unidirectional and/or bidirectional wireless communications between devices 12 and 10, if desired.

During wireless power transmission operations, transistors in inverter 70 are controlled using pulse-width modulation (PWM) control signals (alternating-current signals) from control circuitry 42. Control circuitry 42 uses control path 76 to supply control signals to the gates of the transistors in inverter 70. The duty cycle (on-off ratio) and/or other attributes of these control signals and therefore the corresponding characteristics of the drive signals applied by inverter 70 to coil 36 and the corresponding wireless power signals produced by coil 36 can be adjusted dynamically.

Power source 100 (e.g., battery 38 or source 50 and power converter 40 of FIG. 1) supplies input power to inverter 70. Input power sensor circuitry 106 includes a current sensor that measures input current I_{IN} and a voltage sensor that measures input voltage V_{IN}. Input power P_{IN} is determined by sensor circuitry 106 and/or control circuitry in system 8 such as control circuitry 42 based on dynamic measurements of I_{IN} and V_{IN} (e.g., P_{IN}=I_{IN}*V_{IN}).

Wireless power receiving device 10 has wireless power receiving circuitry 46. Circuitry 46 includes rectifier circuitry such as rectifier 80 (e.g., a synchronous rectifier controlled by signals from control circuitry 20) that converts received alternating-current signals from coil 14 (e.g., wireless power signals received by coil 14) into direct-current (DC) power for powering load 104 (sometimes referred to as a load circuitry 104). Load 104 includes battery 18, a power circuit such as battery charger circuit 86 and other electrical components 102 (e.g., input-output devices 22, control circuitry, communications circuitry, etc.). Battery charger circuitry 86 (e.g., a battery charging integrated circuit or other power management integrated circuit or integrated circuits, sometimes referred to as a power circuit or power integrated circuit(s)) receives power from rectifier circuitry 80 and regulates the flow of this power to battery 18. Components 102 can be turned on and off by control circuitry 20 and/or based on user input. Changes such as these (e.g., turning on or off display 52, using circuitry 86 to charge battery 18 or to stop charging battery 18, and/or other changes in the operation of load 104) affect the amount of power drawn by load 104.

One or more capacitors C are used to couple coil 14 in input circuit 90 of device 10 to the input terminals of rectifier circuitry 80. Rectifier circuitry 80 produces corresponding output power that is supplied to load 104 on path 88. The output power is measured using sensor circuitry in device 10. For example, the amount of current Irec flowing on path 88 between rectifier circuitry 80 and load 104 and the corresponding voltage Vrec on path 88 can be measured by control circuitry 20 using output power sensor circuitry such as current sensor 82 and voltage sensor 84. Sensor circuitry such as sensors 82 and 84 may form part of a rectifier integrated circuit that forms rectifier 80. Control circuitry 20 may, if desired, include control circuitry in the rectifier integrated circuit (e.g., a microcontroller unit in the rectifier integrated circuit). During operation, control circuitry 20 measures output power Pout from rectifier circuitry 80 by determining the product of Irec and Vrec (sometimes referred to as Tout and Vout, respectively).

Electromagnetic coupling (coupling coefficient k) between the coils of the wireless power transmitting device and wireless power receiving device can vary during operation of the wireless power transfer system. For example, a user of a wireless power receiving device may move the wireless power receiving device on a wireless power charging surface, thereby affecting the coupling coefficient. The amount of load power that is consumed in a wireless power receiving device can also vary. For example, a battery in the wireless power receiving device may become depleted and may therefore require recharging, a display, wireless circuit, audio device, or other components in a wireless device may be activated or deactivated during use, and/or other changes in the operation of a wireless power receiving device may require that the amount of power delivered to the load of the wireless power receiving device be changed. Load changes and coupling coefficient changes affect wireless power transfer efficiency. To ensure that system 8 is operating satisfactorily, control operations are implemented on system 8 that allow system 8 to dynamically identify operating parameters to help enhance wireless power transfer efficiency while satisfying output power requirements for load 104.

Rectifier 80 and load 104 are characterized by an effective load resistance RL. The present value of RL (Vrec/Irec) reflects the amount of power being drawn by load 104. The value of load resistance RL is high when load 104 is drawing a relatively small amount of power and is low when load 104 is drawing a large amount of power. Using analytical modeling techniques and/or empirical measurement techniques, the output power Pout of rectifier 80 and wireless power transfer efficiency may be determined as a function of load resistance (RL).

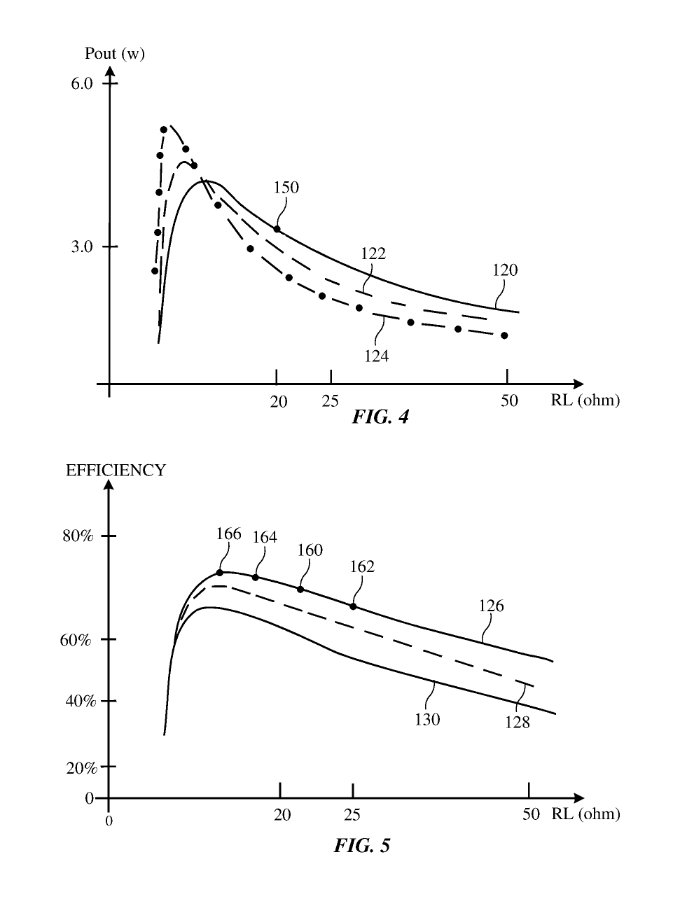

The computed value of output power Pout as a function of load resistance RL in accordance with an illustrative analytical model is shown in FIG. 4 for three illustrative coupling coefficients. Curve 120 corresponds to output power Pout as a function of load resistance RL for a coupling coefficient k of 0.7. Curve 122 corresponds to output power Pout as a function of load resistance RL for a coupling coefficient k of 0.6. Curve 122 corresponds to output power Pout as a function of load resistance RL for a coupling coefficient k of 0.5.

The computed value of wireless power transfer efficiency versus load resistance RL for three illustrative coupling coefficients k is shown in FIG. 5. Curve 126 corresponds to a coupling coefficient of 0.7, curve 128 corresponds to a coupling coefficient of 0.6, and curve 130 corresponds to a coupling coefficient of 0.5 in the example of FIG. 5.

The curves of FIGS. 4 and 5 are illustrative. During operation of system 8, lower and higher coupling coefficients k may be experienced. Higher and lower coupling coefficients than the coupling coefficients of FIGS. 4 and 5 may therefore be characterized, if desired (e.g., k=0.2 to 0.7, k>0.2, k<0.7, etc.).

As the curves of FIGS. 4 and 5 demonstrate, for a given coupling coefficient k, the load resistance value associated with maximum power delivery in system 8 does not generally coincide with the load resistance value associated with maximum efficiency. Situations in which more input power is being consumed than needed while transferring power to the output of rectifier 80 and more output power capability is present than needed by load 104 are characterized by needless circulation of currents in system 8 and wasted power. To search for a satisfactory operating point for system 8, the duty cycle of inverter 70 can be adjusted while measuring input power Pin with input power sensor circuitry 106 and measuring Pout with output power sensor circuitry such as sensor 82 and sensor 84. Assuming that output power Pout remains constant during the search process, the minimum input power point is the maximum efficiency point. In this way, system 8 can elect to operate in a fashion that improves efficiency while delivering sufficient (if not maximum) power to satisfy a demanded load power requirement.

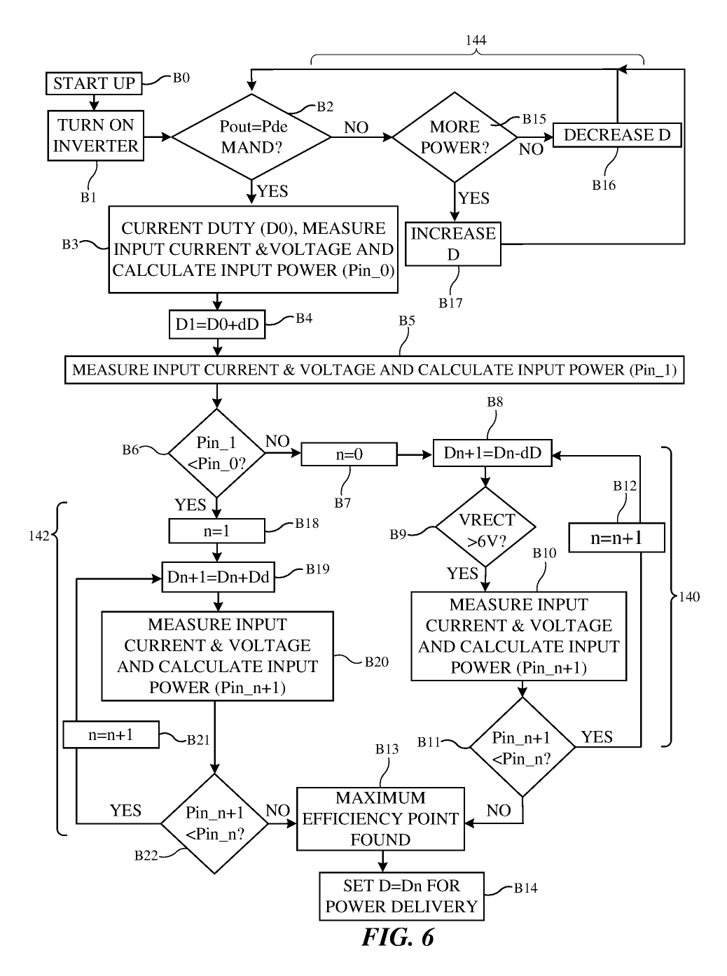

An illustrative duty cycle search process is shown in FIG. 6. This process is performed whenever coupling coefficient k or load resistance RL or other operating parameters in system 8 change.

The search operations of FIG. 6 can be used to identify a duty cycle value for operating inverter 70 that allows system 10 to exhibit peak efficiency for a given set of operating conditions. Consider, as an example, a scenario in which the power demanded by load 104 (e.g., the amount of power needed to satisfactorily operate charging circuit 86, battery 18, and components 102) is 3 W and in which the value of coupling coefficient k is 0.7 and the value of RL is 20 ohms. In this situation, the amount of power Pout that is initially being produced at the load resistance value of 20 ohms (about 3.75 W at point 150 of curve 120 of FIG. 4) exceeds the 3 W being demanded by load 104. There is therefore wasted power in this operating state. By adjusting the duty cycle of inverter 70, a more efficient operating point can be identified.

During operation of system 8, control circuitry 20 in device 10 (e.g., control circuitry associated with battery charger circuitry 86) adjusts the amount of current Idc being drawn by load 104 to maintain an internal direct-current power supply voltage (Vdc) in load 104 at a satisfactory level (e.g., 6 V). Maintaining Vdc at a satisfactory level (e.g., 6 V), ensures that the components in load 104 will be able to operate satisfactorily (e.g., to charge a depleted battery, to power a display, etc.). As the need for power by load 104 fluctuates, the control circuitry (e.g., control circuitry associated with battery charger circuitry 86) adjusts Idc and thereby ensures that Vdc is maintained. The value of the currently demanded load power Pdemand by device 10 (load 104) is the product of the present current setting (Idc) of the battery charger circuitry in load 104 and the value of the power supply voltage in load 104 (Vdc).

As shown in FIG. 6, system 8 performs start-up operations during block BO. During the operations of block BO, wireless power receiving device 10 and wireless power transmitting device 12 communicate wirelessly to execute tasks such as establishing a wireless communications line, identifying the type of receiving device 10 that is present on charging surface 60, etc.

During the operations of block B1, system 8 starts operating with a default duty cycle (e.g., a default duty cycle D0 of 25% or other suitable value). In device 12, control circuitry 42 supplies control signals of duty cycle D0 to inverter 70. This generates wireless power signals for wireless power transmitting circuit 34 that are wirelessly received by wireless power receiving circuit 46. In the example of FIG. 6, Pdemand is 3 W and coupling coefficient k is 0.7. The value of Irec is 0.433 A and Vrec is 8.66 V, so RL is 20 ohm. As a result, operating at the default duty cycle (D0=25%) corresponds to operation at point 160 on efficiency curve 126 of FIG. 5 (and point 150 on Pout curve 120 of FIG. 4). As shown by operating point 150, more output power Pout is being produced than is being demanded (Pdemand is 3 W, but system 8 is capable of producing a Pout value of 3.75 W), so 750 mW is inefficiently circulating in system 8 (in this example).

During the operations of block B2, device 10 (e.g., control circuitry 20) performs one or more tests to determine whether the currently demanded power Pdemand (which is a result of which components are being used by load 104) is being provided at the current value of duty cycle. Control circuitry 20 can then inform control circuitry 42 of whether Pout meets Pdemand so that control circuitry 42 can make appropriate duty cycle adjustments. With one illustrative arrangement, control circuitry 20 uses sensing circuitry such as current sensors 82 and 84 to determine whether power Pdemand is being provided. Control circuitry 20 may, for example, compare a measured value of Vrec from sensor 84 to a predetermined threshold value Vth (e.g., 6 V). If it is determined that Vrec is less than Vth, control circuitry 20 can conclude that the output power supplied by circuitry 80 is insufficient to supply Pdemand. If Vrec is measured as exceeding Vth, than control circuitry 20 can conclude that Pout is exceeding Pdemand. Information on whether Vrec is greater than or less than Vth or other information on whether Pout is satisfying Pdemand can be transmitted from control circuitry 20 to control circuitry 42, so that control circuitry 42 can make duty cycle adjustments.

If Pout and Pdemand are not equal, processing proceeds to the operations of blocks 144. During the operations of block B15, control circuitry 42 can determine whether an increase in output power Pout is needed to meet Pdemand (resulting in an increase in duty cycle D relative to the preset duty cycle at block B17) or whether a decrease in output power Pout is needed (resulting in a decrease in duty cycle D relative to the present duty cycle at block B16). If desired, the magnitude of duty cycle changes (increments and/or decrements) can be varied as a non-linear function of the current duty cycle (e.g., the change made to the current duty cycle at block B17 or B16 may be 1% when the current duty cycle is 5-10%, may be 2% when the current duty cycle is 10-20%, may be 3% when the current duty cycle is 20-25%, may be 4% when the current duty cycle is 25-29%, may be 5% when the current duty cycle is 29-44%, and/or may use other suitable duty-cycle-dependent increment and/or decrement values).

If, during the operations of block B2, it is determined that the output power Pout from rectifier 80 is equal to the power demanded by load 104 (Pdemand), processing may proceed to block B3. During the operations of block B3, the current value of the duty cycle is D0. Control circuitry 42 uses a current sensor in sensor 106 to measure I_{IN} (the current flowing from power supply 100 to inverter 70) and uses a voltage sensor in sensor 106 to measure V_{IN} on node N of FIG. 3. The current value of input power P_{IN} is calculated by multiplying I_{IN} and V_{IN}. The value of P_{IN} at block B3 is recorded as Pin_0.

During the operations of block B4, control circuitry 42 makes a duty cycle adjustment to increment the current duty cycle (e.g., duty cycle D1 is set equal to the previous duty cycle plus and incremental amount dD). The value of the increment of block B4 is 1%, at least 0.1%, less than 10% or other suitable value. If desired, the duty cycle changes (dD—increments and/or decrements) can be varied non-linearly (e.g., the magnitude of dD may depend non-linearly on the magnitude of the current duty cycle, as described in connection with the operations of blocks B17 and B16).

During the operations of block B5, control circuitry 42 uses sensor 106 to measure the I_{IN}, V_{IN}, and thereby measure the updated value of input power P_{IN} (called Pin_1 at block S5).

During the operations of block B6, circuitry 42 determines whether the currently measured value of Pin (Pin_1) is less than the previously measured value of Pin (Pin_0). In the present example, Pin_1 is larger than Pin_0, so efficiency is dropping. The increase of duty cycle at block B4 causes the operating point of system 8 to shift to point 162 on curve 126 of FIG. 5.

Because Pin_1 is not less than Pin_0, control circuitry 20 can conclude that efficiency dropped due to the duty cycle increment imposed at block B4. As a result, processing can proceed to blocks B7 and B8, where system control circuitry 20 respectively initializes a count value n to zero and decrements the duty cycle. If, for example, the default duty cycle D0 was 25%, and if the increment dD of block B4 was 1%, the duty cycle value (Dn+1=D1) is set to D0−dD=24% at block B8. In this example, operation with the 24% duty cycle of block B8 corresponds to operating point 164 on curve 126 of FIG. 5.

During the operations of block B9, control circuitry 20 compares Vrec measured with sensor 84 to Vth (e.g., 6 V) to determine whether Pout is at least Pdemand and wirelessly transmits this information to control circuitry 42. Transmitted information on Pout and Pdemand (e.g., whether Pout is satisfying Pdemand) can be transmitted as binary information (Pout is or is not sufficient to supply Pdemand), can be transmitted in the form of Vrec and Vth data, can be transmitted in the form of Vrec−Vth data, can be transmitted as Pout and Pdemand values and/or values of Pout-Pdemand, and/or can include other information indicative of whether Pout is satisfying demanded power Pdemand. If Vrec is less than 6 V, appropriate action can be taken (e.g., duty cycle can be increased by control circuitry 42 to increase Pout at block B17, etc.). If Vrec is greater than 6 V, control circuitry 42 can measure Pin using sensor 106 during the operations of block B10, thereby obtaining input power value Pin_n+1.

During the operations of block B11, control circuitry 42 determines whether Pin_n+1 is less than Pin_n. If Pin is decreasing (Pin_n+1 is less than Pin_n), efficiency is increasing and the operations of the duty cycle decrement loop (loop 140) can proceed (e.g., index n can be incremented at block B12 and a further duty cycle decrease may be made at block B8, etc.). During the operations of loop 140, device 12 adjusts the duty cycle of the control signals supplied by control circuitry 42 to inverter 70 while control circuitry 42 uses sensor 106 to measure input power Pin. If Pin is increasing (Pin_n+1>Pin_n), the maximum efficiency operating point has been identified (see, e.g., operating point 166 of FIG. 5 and block B13 of FIG. 6) and the operating duty cycle D can be set to Dn for wireless power transfer operations (block B14).

In the event that the test of block B6 determines that Pin_1 is less than Pin_0, operations may proceed to duty cycle incrementing loop 142 instead of duty cycle decrementing loop 140. During loop 142, the operations of block B18 increment index n, the operations of block B19 increment the current duty cycle, the operations of block B20 are used to measure input power, and the operations of block B22 involve testing to determine whether the currently measured input power is greater or less than the previously measured input power. As with the operations of loop 140, device 10 wirelessly transmits information on whether Pout is satisfying Pdemand (e.g., information on whether the current duty cycle is sufficient) to device 12 during the operations of loop 142 that device 12 uses to adjust the duty cycle of the control signals supplied by control circuitry 42 to inverter 70 while control circuitry 42 uses sensor 106 to measure input power Pin. If the input power is decreasing (efficiency has been increased by incrementing the duty cycle), loop 142 continues and index n is incremented at block B21. If the input power is not decreasing, the maximum efficiency point has been identified (B13) and the identified maximum efficiency duty cycle Dn can be used as duty cycle D for wireless power transfer operations B14. The operations of FIG. 6 may be repeated in response to system status changes such as changes to coupling coefficient k and changes to power being consumed drawn by load 104 (e.g., to identify a new efficient operating point for system 8).

The foregoing is illustrative and various modifications can be made to the described embodiments. The foregoing embodiments may be implemented individually or in any combination.

What is claimed is:

1. A wireless power transmitting device configured to transmit wireless power signals to a wireless power receiving device having load circuitry configured to draw a demanded load power, a wireless power receiving coil configured to receive the wireless power signals, rectifier circuitry coupled to the wireless power receiving coil that is configured to supply an output power to the load circuitry based on the wireless power signals received with the wireless power receiving coil, and receiving device control circuitry configured to transmit information on the output power and demanded load power, the wireless power transmitting device comprising:
a wireless power transmitting coil;
an inverter;
sensor circuitry configured to measure an input power to the inverter from a power source; and
transmitting device control circuitry configured to supply control signals to the inverter with a duty cycle that cause the inverter to transmit the wireless power signals from the wireless power transmitting coil and configured to adjust the duty cycle based at least partly on the transmitted information and the measured input power.

2. The wireless power transmitting device defined in claim 1 wherein the transmitting device control circuitry is configured to wirelessly receive the transmitted information.

3. The wireless power transmitting device defined in claim 2 wherein the transmitting device control circuitry is configured to adjust the duty cycle by making duty cycle adjustments that are based at least partly on a current value of the duty cycle.

4. The wireless power transmitting device defined in claim 3 wherein the transmitting device control circuitry is configured to adjust the duty cycle based at least partly on a comparison of the output power and the demanded load power.

5. The wireless power transmitting device defined in claim 4 wherein the transmitting device control circuitry is configured to adjust the duty cycle to identify a minimum value of the input power to the inverter from the power source at which the output power is at least the demanded load power.

6. The wireless power transmitting device defined in claim 1 wherein the transmitting device control circuitry is configured to adjust the duty cycle based at least partly on a comparison of the output power and the demanded load power.

7. The wireless power transmitting device defined in claim 1 wherein the transmitting device control circuitry is configured to adjust the duty cycle to identify a minimum value of the input power to the inverter from the power source at which the output power is at least the demanded load power.

8. A wireless power transmitting device configured to transmit wireless power signals to a wireless power receiving device having load circuitry with a battery and a power circuit coupled to the battery that is configured to draw a demanded load power, a wireless power receiving coil configured to receive the wireless power signals, rectifier circuitry coupled to the wireless power receiving coil that is configured to supply an output power to the load circuitry based on the wireless power signals received with the wireless power receiving coil, and receiving device control circuitry configured to transmit information on the output power and the demanded load power, the wireless power transmitting device comprising:
a wireless power transmitting coil;
an inverter;
sensor circuitry configured to measure an input power to the inverter from a power source; and
transmitting device control circuitry configured to receive the transmitted information, configured to supply control signals to the inverter with a duty cycle that cause the inverter to transmit the wireless power signals from the wireless power transmitting coil, configured to adjust the duty cycle based at least partly on the measured input power and the demanded load power, and configured to adjust the duty cycle to identify a minimum value of the input power to the inverter from the power source at which the output power is at least the demanded load power.

9. The wireless power transmitting device defined in claim 8 wherein the transmitting device control circuitry is configured to wirelessly receive the transmitted information.

10. The wireless power transmitting device defined in claim 9 wherein the transmitting device control circuitry is configured to adjust the duty cycle based at least partly on a comparison of the output power and the demanded load power.

11. The wireless power transmitting device defined in claim 10 wherein the transmitting device control circuitry is configured to adjust the duty cycle by making at least one duty cycle increment and at least one duty cycle decrement.

12. The wireless power transmitting device defined in claim 10 wherein the transmitting device control circuitry is configured to adjust the duty cycle by making at least one duty cycle increment and a plurality of duty cycle decrements.

13. The wireless power transmitting device defined in claim 10 wherein the transmitting device control circuitry is configured to adjust the duty cycle by making duty cycle adjustments of different sizes.

14. The wireless power transmitting device defined in claim 10 wherein the transmitting device control circuitry is configured to adjust the duty cycle by making duty cycle adjustments that are based at least partly on a current value of the duty cycle.

15. A wireless power transmitting device configured to transmit wireless power signals to a wireless power receiving device having load circuitry with a battery and a display and a power circuit coupled to the battery, wherein the load circuitry is configured to draw a demanded load power, the wireless power receiving device having a wireless power receiving coil configured to receive the wireless power signals, rectifier circuitry coupled to the wireless power receiving coil that is configured to supply an output power to the load circuitry based on the wireless power signals received with the wireless power receiving coil, and receiving device control circuitry configured to transmit information on the output power and the demanded load power, the wireless power transmitting device comprising:
a wireless power transmitting coil;
an inverter; and
transmitting device control circuitry configured to supply control signals to the inverter with a duty cycle that cause the inverter to transmit the wireless power signals from the wireless power transmitting coil and configured to adjust the duty cycle based at least partly on a measured input power to the inverter and the demanded load power.

16. The wireless power transmitting device defined in claim 15 wherein the transmitting device control circuitry is configured to adjust the duty cycle to identify a minimum value of an input power to the inverter at which the output power is at least the demanded load power.

17. The wireless power transmitting device defined in claim 16 wherein the inverter is configured to receive the input power from a power source, the wireless power transmitting device further comprising sensor circuitry configured to measure the input power to the inverter from the power source.

18. The wireless power transmitting device defined in claim 17 wherein the transmitting device control circuitry is configured to adjust the duty cycle based at least partly on the measured input power measured by the sensor circuitry.

19. The wireless power transmitting device defined in claim 18 wherein the transmitting device control circuitry is configured to adjust the duty cycle by making at least one duty cycle increment and at least one duty cycle decrement.

20. The wireless power transmitting device defined in claim 18 wherein the transmitting device control circuitry is configured to adjust the duty cycle by making duty cycle adjustments that are based at least partly on a current value of the duty cycle.
